(19) United States
(12) Patent Application Publication
(10) Pub. No.: US 2023/0219785 A1
(43) Pub. Date: Jul. 13, 2023

(54) METHOD FOR OPERATING A PASSENGER CONVEYOR SYSTEM BY RELIABLY CONFIGURING AN ELECTRONIC SAFETY DEVICE

(71) Applicant: Inventio AG, Hergiswil (CH)

(72) Inventor: David Michel, Rotkreuz (CH)

(21) Appl. No.: 17/997,566

(22) PCT Filed: Apr. 16, 2021
(86) PCT No.: PCT/EP2021/059928

§ 371 Date: Oct. 31, 2022

(30) Foreign Application Priority Data
May 8, 2020 (EP) 20173657.6

(51) Int. Cl. B66B 1/34; B66B 1/06; B66B 5/00

(52) U.S. Cl. CPC B66B 1/3407; B66B 1/06; B66B 1/3461; B66B 5/0031

(57) ABSTRACT

A passenger conveyor system has a controller and a safety device monitoring a safety-relevant system function. The safety device is in a “configured” state monitoring the safety-relevant function according to specifications when a target configuration parameter is stored. A system operating method includes: the controller receiving a first configuration parameter and a second configuration parameter created independently of the first parameter; transmitting the first and second parameters to the safety device; wherein the parameters relate to the same target configuration parameter; comparing the first and second parameters in the safety device and, when the parameters match within a prespecified tolerance, storing the corresponding target configuration parameter in the safety device and transmitting the target configuration parameter and/or a “configured” signal from the safety device to the controller. The controller controls the functionalities of the passenger conveyor system according to whether it received the target configuration parameter and/or the “configured” signal.

### FIELD

The present invention relates to a method for operating a passenger conveyor system, to a passenger conveyor system configured to carry out this method, to a computer program product, and to a computer-readable medium.

### BACKGROUND

Passenger conveyor systems, such as elevators, escalators, or moving walks, are used as devices permanently installed in buildings to transport people and/or objects.

Aspects and embodiments of the invention are described below primarily with reference to a passenger conveyor system designed as an elevator system. However, the aspects and embodiments described can also be implemented for other types of passenger conveyor systems.

Passenger conveyor systems must generally meet high safety requirements. For this purpose, multiple safety devices are typically provided in passenger conveyor systems, with the aid of which safety-relevant functions of the passenger conveyor system can be verified—i.e., actively controlled or at least passively monitored. Such safety-relevant functions can include, for example, measurement processes that can be used to determine a current status or current conditions within the passenger conveyor system, such that information obtained in the process can be taken into account when operating the passenger conveyor system.

For example, a safety device in the form of a door sensor or door switch in an elevator system can be used to determine whether an elevator door is correctly closed, such that an elevator controller system can decide based on the information transmitted by multiple such safety devices on different elevator doors of the elevator system whether an elevator car may be moved, or whether this is temporarily not permitted due to the fact that at least one elevator door is not properly closed.

Other safety devices can be configured to provide information about the position at which an elevator car is currently located in an elevator shaft and/or how fast the elevator car is currently moving through the elevator shaft. For this purpose, for example, a sensor can be moved through the elevator shaft together with the elevator car and read out fixed-location information stored within the elevator shaft, from which the current position of the elevator car and the current speed of the elevator car can then be inferred. Based on this information, an elevator controller can move the elevator car precisely to the desired position. A safety device of this type can also monitor that a configurable maximum speed of the elevator car is not exceeded, and can trigger appropriate safety measures when it is detected that the speed has been exceeded.

Another type of safety device can be used to detect whether an elevator car is within a tolerance range above and below a stop position on a floor. Based on this information, the elevator controller can decide, for example, to permit that elevator doors are opened before the elevator car has actually reached a targeted stop position, i.e., while the elevator car is still moving within the tolerance range (so-called pre-opening). In addition, contrary to an otherwise applicable rule that the elevator car may not be moved as long as an elevator door is not completely closed, an elevator controller can exceptionally allow the elevator car to be moved slowly as long as the elevator car is within the tolerance range around the stop position, in order to thereby, for example, be able to bring about level adjustment (so-called relevelling) when passengers enter or leave the elevator car, thereby changing the load and ultimately the position of the elevator car.

In modern passenger conveyor systems, the safety devices can be adapted to operating conditions and/or properties of the passenger conveyor system that are concretely situation-specific and/or system-specific. Such safety devices can thus be referred to as configurable safety devices. For this purpose, the safety devices can be configured, by entering configuration parameters, to be in a state in which they monitor the function to be monitored by them according to certain specifications. Such a state is hereinafter referred to as a “configured” state. The safety device must not be operated in the passenger conveyor system before a safety device has been put into this “configured” state by entering the configuration parameters it requires in a situation-specific or system-specific manner, which means that, as a rule, the entire passenger conveyor system is not yet ready for operation.

In modern passenger conveyor systems, safety devices are increasingly being implemented using electronic and/or programmable circuits. On the one hand, this can lead to the safety devices being able to be adapted to different operating conditions and/or environmental conditions, for example by being able to be individually adapted by storing system-specific and/or situation-specific configuration parameters, in order to monitor the functions to be monitored by them in a prespecified manner. The safety devices in this case can work particularly reliably, be inexpensive and/or be easy to maintain. On the other hand, it can be a challenge to ensure that the configuration parameters used to program the safety devices are correct.

WO 2019/011828 A1 describes a method for configuring safety-relevant configuration parameters in a passenger conveyor system. Patent application EP 19179416 (WO 2020/249475 A1) filed previously by the applicant of this application describes a method for operating a passenger conveyor system with an electronically sealable safety device.

### SUMMARY

Among other things, there may be a need for an alternative approach in order to be able to configure safety devices in passenger conveyor systems in the simplest possible, yet reliable, manner. Furthermore, there may be a need for a passenger conveyor system designed to implement such an approach. Finally, there may be a need for a computer program product designed to carry out the approach presented, and for a computer-readable medium which stores it.

A need of this kind can be satisfied by the subject matter according to any of the advantageous embodiments defined in the following description.

According to a first aspect of the invention, a method for operating a passenger conveyor system is proposed. The passenger conveyor system has a controller for controlling functionalities of the passenger conveyor system, and at least one safety device for monitoring a safety-relevant function of the passenger conveyor system. By storing a target configuration parameter, the safety device can be configured to be into a “configured” state for the purpose of monitoring the safety-relevant function in accordance with certain specifications. The method comprises at least the following steps, preferably in the order provided:
receiving a first configuration parameter and a second configuration parameter—created independently of the first configuration parameter—by the controller, the first configuration parameter and the second configuration parameter relating to the same target configuration parameter;
transmitting the first configuration parameter and the second configuration parameter to the safety device; and
comparing the first configuration parameter and the second configuration parameter in the safety device and, in the event that the first and the second configuration parameter match within a prespecified tolerance, storing a target configuration parameter corresponding to the first and second configuration parameter in the safety device and transmitting the target configuration parameter and/or a “configured” signal from the safety device to the controller.

The controller controls the functionalities of the passenger conveyor system according to whether it received the target configuration parameter and/or the “configured” signal.

It is possible that a plurality of first configuration parameters and a plurality of second configuration parameters are also transmitted to one or more safety devices, and that a plurality of target configuration parameters is derived therefrom and stored in one or more of the safety devices.

According to a second aspect of the invention, a passenger conveyor system is proposed which has a controller for controlling functionalities of the passenger conveyor system, and at least one safety device for monitoring a safety-relevant function of the passenger conveyor system. By storing a configuration parameter, the safety device can be configured to be in a “configured” state and to monitor the safety-relevant function according to certain specifications. The controller and the safety device are configured to carry out or control the method according to an embodiment of the first aspect of the invention.

According to a third aspect of the invention, a computer program product is described which, when executed in a processor-controlled controller for controlling functionalities of a passenger conveyor system and a processor-controlled safety device for monitoring a safety-relevant function of the passenger conveyor system, instructs the latter to carry out or control the method according to an embodiment of the first aspect of the invention.

According to a fourth aspect of the invention, a computer-readable medium is described, in which a computer program product according to an embodiment of the third aspect of the invention is stored.

Possible features and advantages of embodiments of the invention can be considered, inter alia and without limiting the invention, to be based upon the concepts and findings described below.

As briefly stated in the introduction, modern passenger conveyor systems generally have a plurality of safety devices in order to be able to monitor safety-relevant functions and thus ensure safe operation of the passenger conveyor system. In this case, the safety devices can be configured individually in order to be able to take account of the properties of the individual passenger conveyor system and/or the operating conditions prevailing there. At least one of the named individual configurations of the safety device takes place when the safety device to be configured is already installed in its final position in the passenger conveyor system.

Before the passenger conveyor system is put into operation, its safety devices must be correctly configured. For this purpose, suitable configuration parameters are conventionally created individually for each safety device and transmitted to each of the safety devices. The respective configuration parameters can be entered by a technician at a human/machine interface, for example. The human/machine interface can, for example, correspond to the elevator controller, and/or be integrated into it. Alternatively, the configuration parameters can be retrieved, for example, by the elevator controller or a device connected to it, for example from an electronic data source. The configuration parameters are then sent from the elevator controller to the respective safety devices. The safety device saves the received configuration parameters, and can then be operated with the appropriate configuration. In order to be able to check whether the safety device has received and stored the correct configuration parameters, it can be provided that the configuration parameters are transmitted from the safety device back to the elevator controller and/or the human/machine interface connected to it. There, the configuration parameters sent back can then be checked by the technician and/or compared with target values.

However, it has been recognized that errors can occur in the configuration process described above. For example, during data transmission from the human/machine interface to the elevator controller and/or from the elevator controller to the safety device, the data to be transmitted may be modified accidentally or due to a systematic error, such that the data that actually reach the safety device are incorrect.

In the worst case, systematic errors can occur during the data transmission to the safety device and the subsequent return of data back to the elevator controller and/or the human/machine interface, such that modifications made to the data for the outbound transmission can then be compromised when the data is transmitted back to the elevator controller and/or the human/machine interface, and thus cannot be detected by a monitoring technician, for example.

In addition, it has been recognized that considerable effort is often required when configuring the safety devices, firstly to enter the configuration data, and secondly, in particular, to check the consistency of the information about the stored configuration data sent back by the respective safety devices.

An approach for eliminating the described deficits of conventional configuration processes in particular will be briefly described below for the proposed method. In this approach, on the one hand two independently created configuration parameters are received in the controller and transmitted to the safety device, and on the other hand these two configuration parameters are directly compared with each other in the safety device, and a target configuration parameter corresponding to these is only stored in the safety device if there is sufficient agreement between the two configuration parameters. The target configuration parameter and/or a “configured” signal is then transmitted back to the controller from the safety device in order to signal to the controller that the safety device has been correctly configured, and/or to allow for a final verification of the target configuration parameter, for example by a technician or by a comparison with target specifications.

The first and the second configuration parameters both relate to the same target parameter for which a predefined value is to be stored in the safety device. The target parameter can indicate, for example, a size of an above-mentioned tolerance range on both sides of a stop position on a floor, or an above-described maximum speed of the elevator car. In other words, the first and the second configuration parameter should ideally be identical, or at most deviate from each other by a prespecified tolerance. However, the two configuration parameters should be created independently of each other. This means that each of the two configuration parameters is created without knowledge of the other configuration parameter. For example, the two configuration parameters can be created using different data sources. This approach creates a situation in which the probability that both configuration parameters do not correctly reflect the desired configuration, but still match, is extremely low.

The two configuration parameters are then transmitted from the controller to the safety device. The two configuration parameters are compared with each other in the safety device. If the two configuration parameters received are identical, or at least match to a sufficient degree within the specified tolerance, this is taken as an indicator that the two configuration parameters correctly reflect the target specifications. A corresponding target configuration parameter, which either corresponds to the two identical configuration parameters or is at least within the specified tolerance around the two configuration parameters, is then stored in the safety device. It is also possible that, in the case in which the two configuration parameters match sufficiently at least within the specified tolerance, one of the two configuration parameters is adopted as the target configuration parameter. It can be possible to specify which of the two configuration parameters is adopted.

In that the two independently created configuration parameters are not compared with each other until they are in the safety device itself minimizes the risk of the configuration parameters being modified with errors during their data transmission to the safety device, and then being stored in the safety device with corresponding errors. If the configuration parameters are modified during this data transmission, there is a high probability that when the received configuration parameters are compared in the safety device, a lack of agreement will be detected, and the safety device will prevent subsequently storing incorrect configuration parameters.

Only in the event that the two configuration parameters created independently of each other sufficiently match even after they have been transmitted from the controller to the safety device is the corresponding target configuration parameter stored in the safety device. As a result, it is then configured correctly. On the other hand, only in this case is a transmission of the target configuration parameter or a “configured” signal initiated by the safety device to the controller in order to inform the controller that the safety device has been correctly configured.

The controller is designed in such a way that it controls the functionalities of the passenger conveyor system according to whether it has previously received the target configuration parameter or the “configured” signal. This is to be understood in this case as meaning that the controller controls the passenger conveyor system differently after receiving the target configuration parameter or the “configured” signal than before the reception. The controller can, for example, control the passenger conveyor system before the reception in such a way that moving parts of the passenger conveyor system, such as an elevator car of an elevator system, are not moved at all or only very slowly, i.e., more slowly than in normal operation of the passenger conveyor system. Moving parts are moved at a normal speed only after the reception. Also, additional types of actuation of the passenger conveyor system are conceivable depending on the reception mentioned.

If the target configuration parameter was sent back to the controller, it can be checked there, or in a device which communicates with the controller, to further increase the reliability of the method described. For example, a technician can check the target configuration parameter which was sent back, or the target configuration parameter can be compared manually or automatically with target specifications.

In particular, the controller is designed in such a way that it actuates the functionalities of the passenger conveyor system designed as an elevator system in such a way that an elevator car of the passenger conveyor system is only moved in an elevator shaft after the controller has received the target configuration parameter and/or the “configured” signal. This ensures that the elevator car is only moved after the safety device has been configured. This allows a particularly safe operation of the elevator system.

The controller can be designed in particular to actuate the functionalities of the passenger conveyor system to a limited extent before the reception of the target configuration parameter or the “configured” signal, and to actuate the functionalities of the passenger conveyor system to an unlimited extent after the reception. For example, the limited operation may be referred to as a start-up or maintenance mode, and the unlimited operation may be referred to as a normal mode.

According to one embodiment, the controller can receive the first configuration parameter or the second configuration parameter as the result of a manual input which must be carried out by a person at a human/machine interface.

In other words, one of the configuration parameters to be received by the controller can be obtained because a person, such as an authorized technician, enters this configuration parameter at a human/machine interface. Such a human/machine interface can be an integral part of the controller. Alternatively, the human/machine interface can be provided as a separate device and, for example, be temporarily or permanently coupled to the interface.

The human/machine interface may have an input device via which the person can input data representing the configuration parameter. For example, the human/machine interface can have a keyboard, a touch-sensitive screen or the like for this purpose. In addition, the human/machine interface can have an output device in order to be able to output data in a way that the person can perceive. A screen, a loudspeaker or the like can be used for this purpose, for example.

As such, as part of a configuration process, the person can transmit one of the independently created configuration parameters to the controller via the human/machine interface.

Alternatively or additionally, according to one embodiment, the controller can receive the first configuration parameter or the second configuration parameter by retrieving data from a remote database.

In other words, one of the independently created parameters can be obtained by retrieving it from a database. In this case, the database can be stored remotely from the controller, and in particular also remotely from the passenger conveyor system as a whole, for example on a server or in a data cloud. The controller or a device communicating with it can be connected to this database for data transmission, for example by a wired or wireless data connection.

According to a specific embodiment, data which were created during a design process and/or an order for the passenger conveyor system, and which contain the first configuration parameter and/or the second configuration parameter, or from which the first configuration parameter and/or the second configuration parameter are derivable, can be retrieved from the database.

In other words, one of the configuration parameters to be received by the controller can be created on the basis of data that was previously created when the passenger conveyor system was designed or the passenger conveyor system was commissioned. The safety devices to be installed in the passenger conveyor system are typically selected, and their configuration is planned, at the stage of design or commissioning. Accordingly, detailed information about a target configuration of the individual safety devices of the passenger conveyor system can be found in the data created in the process. This data is typically stored in databases, for example by a manufacturer of the passenger conveyor system and/or the safety devices, and can therefore be retrieved by the controller when required.

According to one embodiment, the controller can receive the first configuration parameter and/or the second configuration parameter from a mobile, processor-controlled data processing device, which can be temporarily coupled to the controller for data exchange.

In other words, the controller can be coupled at least temporarily to a mobile, processor-controlled data processing device and can receive configuration parameters via this device. The data processing device can be, for example, an intelligent telephone (for example, a smartphone), a portable computer (for example, a laptop) or a similar portable device equipped with a processor for data processing. The data processing device can, for example, be carried by an authorized technician and/or coupled to the controller. For example, the data processing device can be a smartphone belonging to the technician, on which a special application (app) has been installed. Data transmission between the data processing device and the controller can be wired or wireless. In addition to its processor, the data processing device can also have a data memory in which data can be stored, and/or data interfaces via which data can be exchanged with other devices. Furthermore, the data processing device can have a human/machine interface via which data can be input by a person and/or data can be output in a way that the person can perceive.

After being coupled to the controller, the data processing device can serve as a human/machine interface for the controller. For example, data that reflect one of the configuration parameters can be entered by a person into the data processing device, for example using its keyboard or its touch-sensitive screen. This data can then be relayed to the controller.

Alternatively or additionally, the data processing device can be used to retrieve data that reflect one of the configuration parameters, for example from a remote database, and then to forward this to the controller.

According to a further embodiment, the controller can receive the first configuration parameter or the second configuration parameter from a data memory which is coupled to the controller for data exchange.

In contrast to the data processing device described above, the data memory itself does not need to have any data processing capability, i.e., it does not require its own processor. Instead, the data memory can simply store data and make it available to the controller for retrieval when required. In contrast to the data processing device, the data memory usually does not have its own energy supply. The data memory can be a volatile or non-volatile memory. For example, the data memory can be a flash memory, for example in the form of a SIM card or SD card.

The data stored in the data memory can represent configuration parameters. In this case, this data can have been created independently of data representing configuration parameters, which are made available to the controller via other channels. For example, the data stored in the data memory can have been determined and stored in advance by a manufacturer of the safety device or a manufacturer of the controller.

After the safety device has compared the two configuration parameters which were transmitted to it by the controller and which originate from different sources, and has stored the target configuration parameter if the two configuration parameters match sufficiently, the safety device can transmit the “configured” signal to the controller as confirmation that the target configuration parameter has been saved. As an alternative or in addition, the safety device itself can transmit the target configuration parameter to the controller. The controller can evaluate the correct receipt of this target configuration parameter as an indication that the safety device has been configured correctly. Alternatively, the target configuration parameter can be analyzed in order to identify, for example, whether it corresponds to predetermined target specifications. This can be done within the controller itself, for example.

Alternatively or additionally, according to one embodiment, the controller can transmit the target configuration parameter to a mobile, processor-controlled data processing device.

The data processing device can be the same device which was described above and which is used to input one of the configuration parameters. Alternatively, a different data processing device can also be provided for this purpose, which can be structurally and/or functionally identical or similar in design to the data processing device described above.

The data processing device can then be used, for example, as a human/machine interface, for example in order to output the transmitted target configuration parameters in a way that the technician can perceive. Alternatively, the data processing device can use its data communication interfaces to transmit the received target configuration parameters, for example to external devices such as a monitoring device for monitoring functionalities of the elevator system.

According to a specific embodiment, the data processing device can output the target configuration parameter to a person and, if the person confirms that the target configuration parameter is correct, can transmit a “sealed” signal to the controller. The controller can be designed to actuate the functionalities of the passenger conveyor system at most to a limited extent before receiving the “sealed” signal, and to actuate the functionalities of the passenger conveyor system to an unlimited extent after receiving the “sealed” signal.

In other words, the data processing device can be used to enable, for example, an authorized technician to check the correctness of the target configuration parameters transmitted from the safety device to the controller, and then on to the data processing device. For this purpose, the technician can compare the information about the target configuration parameter output by the data processing device with other information available to him—for example, information about target specifications. It can be provided that the elevator system may only be operated with its full range of functions if such a check was performed by an authorized technician. In the case of conventional elevator systems, it can be provided that the safety device is sealed after it has been checked by the technician—that is, it is provided with an anti-tamper seal, for example. In the approach described here, sealing can take place electronically, i.e., the controller can be designed to only allow the full range of functions of the elevator system if the target configuration parameter which was stored by the safety device and subsequently transmitted has been checked by the technician and its correctness has been confirmed.

For this purpose, the technician can, for example, make an entry on the mobile data processing device to confirm the correctness, on the basis of which the “sealed” signal is then transmitted to the controller of the elevator system. Only after receipt of this “sealed” signal does the controller go from a restricted operating mode in which safety-relevant functionalities of the passenger conveyor system are permitted at most to a limited extent, to a normal operating mode in which all safety-relevant functionalities of the passenger conveyor system are permitted and monitored by the controller.

According to a specific embodiment, the controller can transmit the “sealed” signal to the safety device, and the safety device then changes to a sealed state after receiving the “sealed” signal. The safety device then transmits an “acknowledged” signal to the controller. The controller is provided to actuate the functionalities of the passenger conveyor system at most to a limited extent before receiving the “acknowledged” signal, and to actuate the functionalities of the passenger conveyor system to an unlimited extent after receiving the “acknowledged” signal.

As soon as the safety device is in the sealed state, modified configuration parameters can only be stored in the safety device under increased security conditions, for example by entering a special authorization code. In this way, unauthorized modifications to the configuration parameters can be prevented in a particularly effective manner, which enables the passenger conveyor system to be operated in a particularly safe manner.

The described electronic sealing can employ techniques and/or method steps similar to those described in patent application EP 19179416 (WO 2020/249475 A1) previously filed by the applicant of this patent application.

According to one embodiment, the first configuration parameter and/or the second configuration parameter is/are each transmitted from the controller to the safety device together with a checksum that characterizes the respective configuration parameters.

In other words, the respective configuration parameters are preferably not transmitted as the sole data between the controller and the safety device; rather, the data representing a configuration parameter are supplemented by data which represent a checksum characterizing the respective configuration parameters.

Such a checksum can be used as part of a cyclic redundancy check and is therefore sometimes also referred to as a CRC. The cyclic redundancy check is a procedure in which a check value is determined for data in order to be able to detect errors in data transmission or storage. Ideally, the method can even be used to independently correct received data in order to avoid retransmission. Before the data transmission and/or data storage in memory, for example, an additional redundancy, in the form of a so-called CRC value, is added for a data block of user data. The CRC value acts as a checksum and is a test value calculated according to a specific procedure, which can be used to detect any errors that may have occurred during storage or transmission. Accordingly, by adding the checksum that characterizes the individual configuration parameter, a risk of undetected errors occurring during the transmission of the configuration parameters from the controller to the safety device can be minimized.

According to one embodiment, the method proposed here is designed in such a way that a dataset representing the first configuration parameter and/or the second configuration parameter is not modified by the controller before it is transmitted to the safety device.

In other words, the controller of the passenger conveyor system should not process or modify the configuration data it has received in any way, if possible, but rather forward the data directly to the safety device without any changes. In this context, a dataset representing a configuration parameter is to be understood as the representation of the configuration parameter using computer code. For example, if a configuration parameter is transmitted to the controller in the form of a logical bit sequence, the controller forwards precisely this bit sequence to the safety device. In this case, it is possible for the controller to transmit further information, for example an above-mentioned checksum, to the safety device immediately before or after the bit sequence mentioned.

Preferably, the controller should also not modify the dataset which reflects the target configuration parameter transmitted back from the safety device in any way before it is output at the human/machine interface, for example.

This is intended in particular to prevent the configuration parameters received from the controller being passed on incorrectly to the safety device, for example due to systematic errors which could occur during data processing within the controller. In particular, it should be avoided that both the first at least one configuration parameter and the second at least one configuration parameter are processed incorrectly in the same systematic way, and then both configuration parameters are recognized as the same on the safety device, but both configuration parameters are not correct. In the worst case, the target configuration parameter then sent back from the safety device to the controller would be incorrectly processed by the controller in the opposite way, such that the incorrect data modifications that had occurred in the meantime would be compensated for and the storage of incorrect configuration parameters in the safety device would not be noticed even during a check by the authorized technician.

In the passenger conveyor system according to the second aspect of the invention, the controller thereof and the at least one safety device thereof are designed in such a way that they can carry out the method described herein, and thus ensure correct configuration of the safety device.

In this case, the controller can be designed to exchange signals or data with various actuators and/or sensors within the passenger conveyor system. In particular, the controller can control the operation of a drive machine of the passenger conveyor system. If necessary, the controller can also accept inputs from various human/machine interfaces in order to accordingly control the operation of the passenger conveyor system, or can output information relating to a current state of the passenger conveyor system via human/machine interfaces. For example, such human/machine interfaces can include buttons, knobs, sensors, screens, loudspeakers and/or the like on control panels of an elevator system. The controller can, for example, have individual modules that communicate with each other, with one module performing safety-relevant tasks, for example, and another module serving the human/machine interfaces and actuating a drive machine.

The safety device can be designed to monitor a safety-relevant function within the passenger conveyor system. To this end, the safety device can have one or more sensors in order to be able to detect physical quantities which correlate with the safety-relevant function. The safety device may also have one or more actuators with which such physical quantities can be influenced.

The safety device can also have a modular structure, i.e., it can have a plurality of different modules which have different functions. In particular, a plurality of modules can be configured, and each module monitors a safety-relevant function of the passenger conveyor system. The safety device then transmits the “configured” signal or the “sealed” signal to the controller only when all configurable modules have been configured.

For example, safety devices can be designed to detect a current opening state of an elevator door, to measure a current travel speed of an elevator car, to determine a current location of the elevator car within an elevator shaft, to detect a load or acceleration currently acting on the elevator car, or the like.

By storing the target configuration parameter, the safety device can be adapted to properties of the passenger conveyor system and/or to the conditions prevailing in the passenger conveyor system.

The method described here can be carried out by a processor-controlled controller of a passenger conveyor system in cooperation with a processor-controlled safety device. Both the controller and the safety device can execute a program code that is part of a computer program product according to the third aspect of the invention. The computer program product can thus instruct the controller and the safety device to carry out or control the respective sub-steps of the method described herein that are to be carried out by them. The computer program product can be formulated in any computer language.

Such a computer program product can be stored on a computer-readable medium according to the fourth aspect of the invention. Such a medium can be any volatile or non-volatile data storage medium. For example, the computer-readable medium can be a portable data storage medium, for example in the form of a flash memory, a DVD, a CD or the like. The computer-readable medium can also be part of another computer or server or part of a data cloud from which the computer program product can be downloaded, for example over a network such as the Internet.

It should be noted that some of the possible features and advantages of the invention are described herein with reference to different embodiments of a method for operating a passenger conveyor system, on the one hand, and an accordingly embodied passenger conveyor system, on the other hand. A person skilled in the art will recognize that the features can be suitably combined, adapted, or replaced in order to arrive at further embodiments of the invention.

Embodiments of the invention will be described below with reference to the accompanying drawings; neither the drawings nor the description should be interpreted as limiting the invention.

### DESCRIPTION OF THE DRAWINGS

FIG. 1 shows an elevator system according to an embodiment of the present invention.

FIG. 2 is a diagram to illustrate data transmissions and data processing as part of a method according to an embodiment of the present invention.

The drawings are merely schematic and not to scale. Like reference signs denote like or equivalent features in the various drawings.

### DETAILED DESCRIPTION

In the following, only one target configuration parameter is determined from a first and a second configuration parameter, and is stored in a safety device. However, this is not to be interpreted restrictively. It is also possible for a plurality of first configuration parameters and a plurality of second configuration parameters to be transmitted to one or more safety devices in an analogous manner, and for a plurality of target configuration parameters to be derived therefrom, which are stored in one or more of the safety devices.

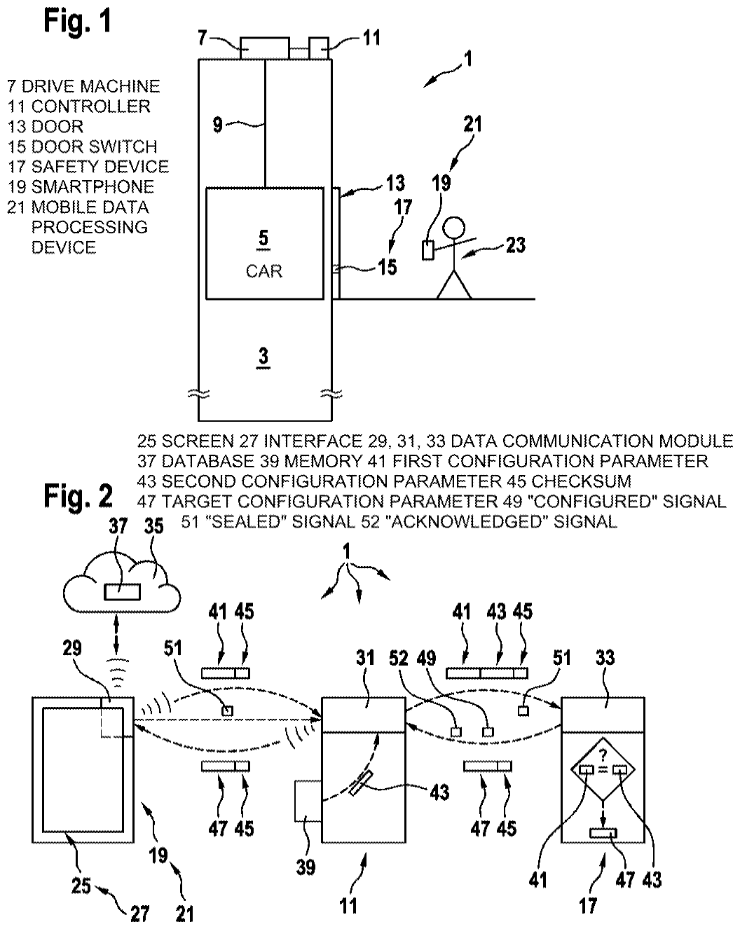

FIG. 1 shows a very rough schematic of a passenger conveyor system 1 in the form of an elevator system. An elevator car 5 is arranged in an elevator shaft 3 and is held by cable-like suspension means 9. A drive machine 7 can move the cable-like suspension means 9 and thus displace the elevator car 5 vertically. The drive machine 7 is controlled by a controller 11. An elevator door 13 is provided at a floor. A current closed state of the elevator door 13 is monitored with a safety device 17 in the form of a door switch 15. Several further safety devices 17 can also be provided in the passenger conveyor system 1 in order, for example, to monitor the closed states of further elevator doors 13, or also other functionalities.

A technician 23 can visit the passenger conveyor system 1 in order to use his smartphone 19 as a mobile data processing device 21 to configure the passenger conveyor system 1, and in particular its safety device 17. This can be done, for example, directly after completion of the passenger conveyor system 1 or as part of maintenance work on the same.

A possible embodiment of such a procedure for configuring the safety device 17 is described with reference to FIG. 2.

First, the controller 11 receives a first configuration parameter 41 and a second configuration parameter 43. The two configuration parameters 41, 43 were previously created independently of each other, but both relate to a desired target configuration of the safety device 17 to be configured.

In the example shown, the first configuration parameter 41 is transmitted to the controller 11 by a mobile, processor-controlled data processing device 21. The data processing device 21 can be a smartphone 19 belonging to the technician 23, on which a suitable application (app) is running. The first configuration parameter 41 can, for example, be entered by the technician 23 via a human/machine interface 27 of the smartphone 19. The human/machine interface 27 can be, for example, a touch-sensitive screen 25 or a keyboard. Alternatively, the first configuration parameter 41 can also be retrieved from an external source such as an external database 37 held in a data cloud 35, using a data communication module 29 of the smartphone 19. For example, configuration data can be stored in the database 37, that were created during a conceptual design process or when the passenger conveyor system 1 was commissioned. The first configuration parameter 41 can then, for example, also be transmitted to the controller 11 or its data communication module 31 using the data communication module 29. For example, the data can be transmitted wirelessly.

Furthermore, in the example shown, the second communication parameter 43 is provided by a data memory 39 which is coupled to the controller 11 for data exchange. This data memory 39 can be a flash memory, for example, on which configuration data for all safety devices 17 of the passenger conveyor system 1 are stored.

Both the first and the second configuration parameters 41, 43 are then transmitted from the controller 11 to the safety device 17 or to its data communication module 33. The datasets representing the first and second configuration parameters 41, 43, i.e., their representation using computer code, are particularly not modified by the controller 11. The two transmitted configuration parameters 41, 43 are then compared with each other in the safety device 17. If the two configuration parameters 41, 43 match within a specified tolerance, a target configuration parameter 47 corresponding to the two configuration parameters 41, 43 is stored in the safety device 17. In addition, the target configuration parameter 47 is also sent back to the controller 11. Alternatively or additionally, a “configured” signal 49 can be transmitted to the controller 11.

As a result of it receiving the target configuration parameter 47 and/or the “configured” signal 49, the controller 11 can recognize that the safety device 17 has been configured correctly and can correctly perform its monitoring function of the passenger conveyor system 1. The controller 11 can adapt the actuation of the functionalities of the passenger conveyor system 1 accordingly. For example, the controller 11 can actuate the drive machine 7 in such a way that the elevator car 5 is displaced in the elevator shaft 3, or that it is displaced at a speed for normal operation of the passenger conveyor system 1, only at that point.

After recognizing the correct configuration of the safety device 17, the controller 11 can change from a previous restricted mode, in which the functionalities of the passenger conveyor system 1 were at best limited, to a normal mode in which the functionalities of the passenger conveyor system 1 are fully available.

Furthermore, the controller 11 can send the target configuration parameter 47 to the mobile data processing device 21. The dataset representing the target configuration parameter 47, i.e., its representation using computer code, is particularly not modified by the controller 11. For example, the technician 23 can analyze this returned target configuration parameter 47 in the data processing device 21, for example by comparing it with the data previously entered by the technician 23 or by comparing it with data previously read out from the database 37. In the event that the technician 23 determines that the target configuration parameter 47 is correct, i.e., for example sufficiently corresponds to target specifications, he can confirm the correctness of the target configuration parameter 47 by entering it at the human/machine interface 27, for example. The data processing device 21 can then transmit a “sealed” signal 51 back to the controller 11. As a result of receiving this “sealed” signal 51, the controller 11 can then change from a previous restricted mode, in which the functionalities of the passenger conveyor system 1 were at best limited, to a normal mode in which the functionalities of the passenger conveyor system 1 are fully available.

Instead of switching to the normal mode immediately after receiving the “sealed” signal 51 from the data processing device 21, the controller 11 can transmit the “sealed” signal 51 to the safety device 17. After receiving the “sealed” signal 51, the safety device 17 then switches to a “sealed” state and transmits an “acknowledged” signal 52 to the controller 11. The controller 11 only changes to the normal mode after receiving the “acknowledged” signal 52 from the safety device 17.

In order to ensure the integrity of the data that reflect the various configuration parameters 41, 43, 47, additional checksums 45 can be transmitted together with this data during transmission between the various devices, i.e., between the data processing device 21 and the controller 11 on the one hand or between the controller 11 and the safety device 17 on the other hand, which checksums characterize the respective configuration parameters 41, 43, 47 and/or their data. Such checksums 45 can have been determined in advance as CRC values.

In the example presented above, the first configuration parameter 41 was determined by the mobile data processing device 21 and transmitted to the controller 11, whereas the second configuration parameter 43 was read out from the data memory 39 provided directly on the controller 11. However, it should also be possible to have both the first configuration parameter 41 and the second configuration parameter 43 determined by the data processing device 21. For example, the data processing device 21 can, on the one hand, choose an input from the technician 23 on his screen 25 as the first configuration parameter 41 and, on the other hand, choose data retrieved from the database 37 as the second configuration parameter 43, and then transmit both configuration parameters 41, 43 to the controller 11.

Analogously, it is also conceivable to have both configuration parameters 41, 43 determined directly by the controller 11, for example because it retrieves data from a database 37 via the data communication module 31 integrated in the controller 11 and receives the data as the first configuration parameter 41, on the one hand, and receives data from the data memory 39 as the second configuration parameter 43.

In particular, it is possible with the aid of the method proposed here to configure the safety device 17 without the technician 23 having to enter configuration data manually into a human/machine interface. For example, the safety device 17 can compare first configuration parameters 41 which were automatically read out from the database 37 with second configuration parameters 43 which were automatically read out from the data memory 39. If the two configuration parameters 41, 43 match sufficiently, a corresponding target configuration parameter 47 can be automatically stored in the safety device 17. Based solely on all of these method steps to be carried out automatically, the safety device 17 can then switch to at least partial operation in which its functionalities are available at least to a limited extent and/or in which the functionalities of the entire passenger conveyor system 1 are provided to a limited extent. In partial operation, for example, a speed at which the elevator car 5 can be moved can be limited, or the elevator car 5 can only travel after prior additional confirmation. At a later point in time, for example, the stored target configuration parameter 47 can then be checked by a technician 23 and, if correct, a “sealed” signal 51 can be transmitted to the controller 11, whereupon the controller can then switch to full operation.

Overall, with the approach described here, greater reliability can be achieved when configuring the passenger conveyor system 1, and accordingly, increased security can be achieved for the passenger conveyor system 1. In addition, the configuration process itself can be simplified.

Finally, it should be noted that terms such as “comprising”, “having”, etc. do not exclude other elements or steps, and terms such as “a” or “an” do not exclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for operating a passenger conveyor system, the passenger conveyor system having a controller for controlling functionalities of the passenger conveyor system and a safety device for monitoring a safety-relevant function of the passenger conveyor system, wherein the safety device is configurable to a “configured” state by storing a target configuration parameter to then monitor the safety-relevant function according to predetermined specifications, the method comprising the steps of:
receiving by the controller a first configuration parameter and receiving a second configuration parameter created independently of the first configuration parameter, the first configuration parameter and the second configuration parameter relating to a same target configuration parameter;
transmitting the first configuration parameter and the second configuration parameter to the safety device;
comparing the first configuration parameter and the second configuration parameter in the safety device and, when the first configuration parameter and the second configuration parameter match within a prespecified tolerance, storing the target configuration parameter related to the first configuration parameter and the second configuration parameter in the safety device and transmitting the target configuration parameter and/or a “configured” signal from the safety device to the controller; and
wherein the controller controls the functionalities of the passenger conveyor system according to whether it has received the target configuration parameter and/or the “configured” signal.

17. The method according to claim 16 wherein the passenger conveyor system is an elevator system and the controller controls an elevator car of the elevator system to only move in an elevator shaft after the controller receives the target configuration parameter and/or the “configured” signal.

18. The method according to claim 16 wherein the controller receives the first configuration parameter or the second configuration parameter in response to a manual input by a person at a human/machine interface.

19. The method according to claim 16 wherein the controller receives the first configuration parameter or the second configuration parameter by retrieving data from an external database.

20. The method according to claim 19 wherein the data in the external database was created during a design process and/or a commissioning of the passenger conveyor system and the data contains the first configuration parameter and/or the second configuration parameter, or wherein the first configuration parameter and/or the second configuration parameter can be derived from the data.

21. The method according to claim 16 wherein the controller receives the first configuration parameter and/or the second configuration parameter from a mobile, processor-controlled data processing device that is adapted to be coupled temporarily to the controller for data exchange.

22. The method according to claim 16 wherein the controller receives the first configuration parameter or the second configuration parameter from a data memory that is coupled to the controller for data exchange.

23. The method according to claim 16 wherein the controller transmits the target configuration parameter to a mobile, processor-controlled data processing device.

24. The method according to claim 23 wherein the data processing device outputs the target configuration parameter to a person and, when the person confirms at the data processing device that the target configuration parameter is correct, the data processing device sends a “sealed” signal to the controller, wherein the controller actuates the functionalities of the passenger conveyor system at most to a limited extent before receiving the “sealed” signal, and the controller actuates the functionalities of the passenger conveyor system to an unlimited extent after receiving the “sealed” signal.

25. The method according to claim 24 wherein the controller transmits the “sealed” signal to the safety device, the safety device changes to a sealed state after receiving the “sealed” signal and transmits an “acknowledged” signal to the controller, the controller actuates the functionalities of the passenger conveyor system at most to a limited extent before receiving the “acknowledged” signal, and the controller actuates the functionalities of the passenger conveyor system to an unlimited extent after receiving the “acknowledged” signal.

26. The method according to claim 16 wherein the first configuration parameter and/or the second configuration parameter are each transmitted from the controller to the safety device together with a checksum characterizing the respective configuration parameters.

27. The method according to claim 16 wherein a dataset representing the first configuration parameter and/or the second configuration parameter is not modified by the controller before the dataset is transmitted by the controller to the safety device.

28. A passenger conveyor system comprising:
a controller controlling functionalities of the passenger conveyor system;
a safety device monitoring a safety-relevant function of the passenger conveyor system;
wherein the safety device is configurable to a “configured” state by storing a target configuration parameter to then monitor the safety-relevant function according to predetermined specifications; and
wherein the controller and the safety device are adapted to perform or control the method according to claim 16.

29. A computer program product comprising at least one computer program means for performing the method according to claim 16 when the computer program means is loaded into a processor-controlled controller for controlling functionalities of a passenger conveyor system and a processor-controlled safety device for monitoring a safety-relevant function of the passenger conveyor system.

30. A non-transitory computer-readable medium on which the computer program product according to claim 29 is stored.
